(19) United States
(12) Patent Application Publication
(10) Pub. No.: US 2015/0362021 A1
(43) Pub. Date: Dec. 17, 2015

(54) ALUMINUM CLUTCH COMPONENTS WITH FERROUS SURFACE

(71) Applicant: GM Global Technology Operations LLC, Detroit, MI (US)

(72) Inventor: Scott William HEITZENRATER, Orion, MI (US)

(21) Appl. No.: 14/710,120

(22) Filed: May 12, 2015

Related U.S. Application Data
(60) Provisional application No. 62/011,988, filed on Jun. 13, 2014.

(51) Int. Cl. F16D 13/58

(52) U.S. Cl. CPC F16D 13/58

(57) ABSTRACT

A component for a friction clutch assembly utilized in automatic transmissions, such as an outer housing, hub or carrier, exhibits reduced weight and speed sensing capability. An outer clutch housing, a clutch hub or a carrier including integral tone wheel openings are fabricated of aluminum and the tone wheel includes a coating of a thin layer of thermally sprayed steel material. Alternatively, a circumferential area of the housing, hub or carrier lacking tone wheel openings may be masked in an interrupted or discontinuous path and thermally sprayed to provide steel, teeth-like regions or patches. The thermally sprayed steel material may be a low carbon steel such as SAE 1008 or 1010, a similar alloy or iron. The resulting component thus exhibits the weight saving of aluminum and cooperates with a magnetic speed sensor to provide rotational speed sensing capability.

### CROSS REFERENCE TO RELATED APPLICATION

This application claims the benefit of U.S. Provisional Patent Application Ser. No. 62/011,988, filed Jun. 13, 2014, which is hereby incorporated in its entirety herein by reference.

### FIELD

The present disclosure relates to aluminum clutch components and more particularly to an aluminum clutch housing, hub or carrier including a tone wheel including a thin layer of steel or iron disposed on a surface.

### BACKGROUND

The statements in this section merely provide background information related to the present disclosure and may or may not constitute prior art.

A typical and conventional automatic transmission includes a plurality of planetary gear assemblies and friction clutch assemblies. The friction clutches include pluralities of alternating friction plates and reaction plates disposed between an inner hub with which the friction plates rotate and an outer housing with which the reaction plates rotate. When the friction plates and reaction plates are compressed, torque is transmitted between the inner hub and the outer housing.

It is frequently either desirable or necessary to sense the rotational speed of the outer housing, hub or carrier to monitor operation of the transmission and this is achieved by including a tone wheel to the housing and disposing a magnetic speed sensor proximate such tone wheel. Typically, the tone wheel will include a plurality of teeth similar to gear teeth or a circumferential track or array of slots or openings.

The housing, hub or carrier is typically fabricated of various steels due to the strength and durability this material provides. The tone wheel is also fabricated of steel and may be a separate part secured to the housing, hub or carrier by, for example, staking, or integrally cast or formed with the housing, but in this case, not because of strength and durability but because of the magnetic properties of steel which cooperate with the magnetic speed sensor.

While various steels provide the necessary strength, durability and magnetic sensing in this service, they are not without drawbacks. The primary contemporary issue with such steel components is weight. Since these components are both carried and translated as part of the total vehicle weight and rotate and thus contribute to powertrain energy loss as they are repeatedly accelerated, they twice contribute to fuel consumption. Accordingly, any weight reduction of a rotating component, such as a clutch housing or hub, positively affects fuel consumption both from the standpoint of total vehicle weight as well as powertrain efficiency.

A solution to the weight problem is the substitution of a lighter weight material such as aluminum. Aluminum has about one-third the density of steel and exhibits good heat transfer, both characteristics being beneficial in transmission applications. However, it has been found that an aluminum housing or hub including a tone wheel is unsuitable because rotation of an aluminum tone wheel cannot be sensed by a conventional magnetic speed sensor such as a Hall effect sensor.

A solution to this problem entails fabricating the housing or hub of aluminum, the tone wheel of a magnetic material such as steel and pressing on and staking the tone wheel to the housing of hub. The manufacture of two separate components and the assembling operation, however, renders this alternative unattractive.

### SUMMARY

The present invention provides components for a friction clutch assembly utilized in automatic transmissions, such as an outer housing, hub or carrier, having reduced weight as well as speed sensing capability. An outer clutch housing, a clutch hub or a carrier including integral tone wheel openings are fabricated of aluminum, cast aluminum or a formed aluminum sheet and the tone wheel region includes a coating of a thin layer of thermally sprayed steel material. Alternatively, a circumferential area or radial face of the housing, hub or carrier lacking tone wheel openings may be masked in an interrupted or discontinuous path and then thermally spray coated to provide steel, teeth-like regions or patches. The thermally sprayed steel material may be a low carbon steel such as SAE 1008 or 1010 or a similar alloy, metal or iron. The resulting component thus exhibits the weight saving of aluminum and cooperates with a magnetic speed sensor to provide rotational speed sensing capability.

As a further alternative, a circumferential area or radial face of the housing, hub or carrier lacking tone wheel openings may be thermally spray coated to provide steel, teeth-like regions or patches. The thermally sprayed material may be low carbon steel such as SAE 1008 or 1010 or a similar alloy, metal or iron. It can then be machined by hobbing, shaper cutting, milling or a similar process to remove patches or regions of the thermally sprayed steel and aluminum. What remains is steel coated aluminum teeth-like regions or patches. The resulting component thus also exhibits the weight saving of aluminum and cooperates with a magnetic speed sensor to provide rotational speed sensing capability.

It is thus an aspect of the present invention to provide a friction clutch component fabricated of aluminum and having a thin layer of thermally sprayed steel material disposed on a tone wheel.

It is a further aspect of the present invention to provide an outer housing for a friction clutch assembly fabricated of aluminum and having a thin layer of thermally sprayed steel material disposed on a tone wheel.

It is a still further aspect of the present invention to provide a hub for a friction clutch assembly fabricated of aluminum and having a thin layer of thermally sprayed steel material disposed on a tone wheel.

It is a still further aspect of the present invention to provide a carrier for a friction clutch assembly fabricated of powdered metal aluminum, cast aluminum or a formed aluminum sheet and having a thin layer of thermally sprayed steel material disposed on a tone wheel.

It is a still further aspect of the present invention to provide an outer housing for a friction clutch assembly fabricated of aluminum and having a thin layer of thermally sprayed SAE 1008 or 1010 steel material disposed on a tone wheel.

It is a still further aspect of the present invention to provide a hub for a friction clutch assembly fabricated of aluminum and having a thin layer of thermally sprayed SAE 1008 or 1010 steel material disposed on a tone wheel.

It is a still further aspect of the present invention to provide a carrier for a friction clutch assembly fabricated of powdered metal aluminum, cast aluminum or a formed aluminum sheet and having a thin layer of thermally sprayed SAE 1008 or 1010 steel material disposed on a tone wheel.

It is a still further aspect of the present invention to provide an outer housing for a friction clutch assembly fabricated of aluminum and having a plurality of interrupted regions of thermally sprayed steel material disposed on a circumferential surface or a radial face.

It is a still further aspect of the present invention to provide a hub for a friction clutch assembly fabricated of aluminum and having a plurality of interrupted regions of thermally sprayed steel material disposed on a circumferential surface or a radial face.

It is a still further aspect of the present invention to provide a carrier for a friction clutch assembly fabricated of powdered metal aluminum, cast aluminum or a formed aluminum sheet and having a plurality of interrupted regions of spray bore steel material disposed on a circumferential surface or a radial face.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a fragmentary sectional view of a portion of an automatic transmission including a speed sensor and an adjacent rotating component including a thermally sprayed coating;

FIG. 2 is an enlarged fragmentary perspective view of a an aluminum hub, housing or carrier including a tone wheel having a thermally sprayed coating applied to a discontinuous surface;

FIG. 3 is a fragmentary perspective view wherein a portion of a continuous surface of a clutch hub, housing or carrier is masked prior to thermally spray coating thin metal patches or bars on a continuous surface; and

FIG. 4 is a fragmentary perspective view of an aluminum hub, housing or carrier including a tone wheel having a thermally sprayed coating applied in discontinuous regions to a circumferential surface according to the present invention;

### DETAILED DESCRIPTION

The following description is merely exemplary in nature and is not intended to limit the present disclosure, application, or uses.

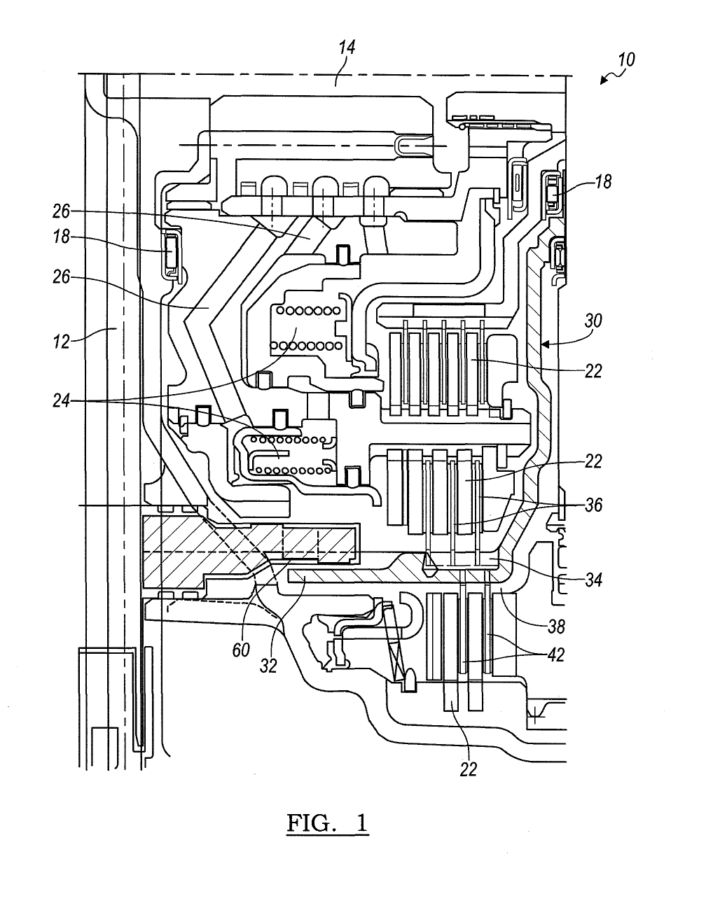

With reference to FIG. 1, a portion of a motor vehicle automatic transmission is illustrated and generally designated by the reference number 10. The automatic transmission 10 includes a housing 12 which mounts, positions and protects various components such as a plurality of shafts or quills 14, one of which is illustrated in FIG. 1, a plurality of bearings 18, a plurality of friction clutch assemblies 22, a plurality of hydraulic clutch actuator assemblies 24 and a plurality of fluid passageways 26.

Disposed between and functioning and associated with two of the friction clutch assemblies 22 is a housing, hub or carrier 30 which rotates about the axis of the shaft 14. The housing, hub or carrier 30 includes an annular or cylindrical portion 32 having interior or female splines 34 which engage friction plates 36 in one of the friction clutches 22 and exterior or male splines 38 which engage friction plates 42 in another one of the friction clutches 22.

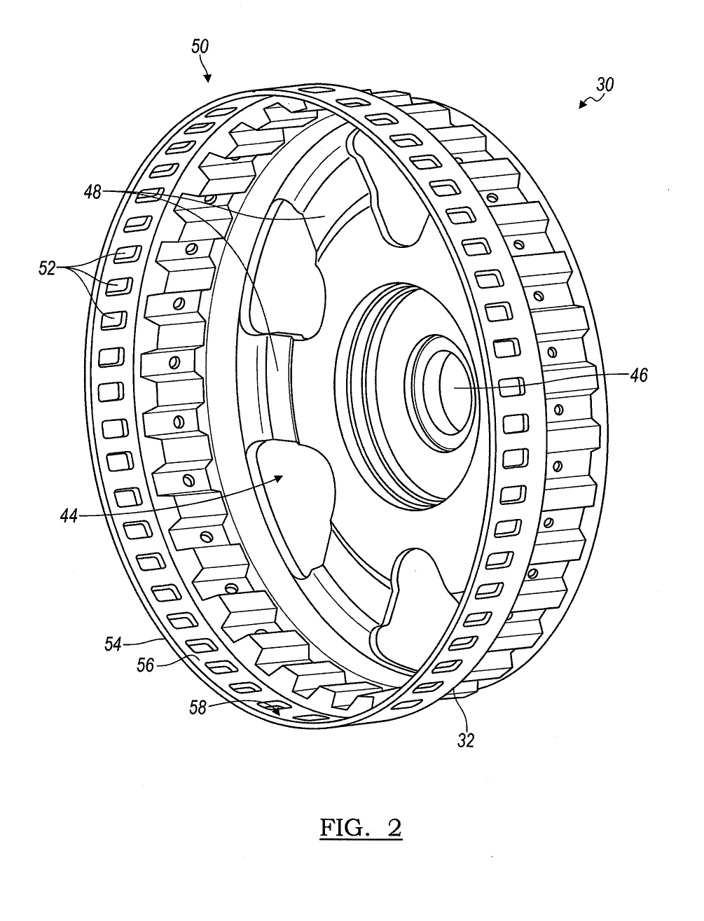

Referring now to FIGS. 1 and 2, the housing, hub or carrier 30 includes an end panel 44 which connects the annular portion 32 with a mounting bushing or bearing housing 46 which receives the shaft 14. The end panel 44 may either be solid or, in order to save weight and as illustrated in FIG. 2, comprise a plurality of radially extending spokes 48.

The annular portion 32 of the housing, hub or carrier 30 also includes a tone wheel 50 which defines a plurality of openings or slots 52 circumferentially disposed about and adjacent the open end edge 54 of the annular portion 32 of the housing, hub or carrier 30. Disposed in sensing relationship with the tone wheel 50 of the housing, hub or carrier 30 is a magnetic speed sensor 60 such as a Hall effect sensor or similar device. The output of the speed sensor 60 is provided to a transmission control module (TCM) or other, similar vehicle or engine control device (not illustrated).

The housing, hub or carrier 30 is fabricated of aluminum. The interior surface 56 of the annular portion 32 of the housing, hub or carrier 30 adjacent the open end edge 54 and axially slightly beyond the openings or slots 52 is thermally spray coated with a thin steel or ferrous coating 58. SAE 1008 and 1010 steels and iron as well as other ferrous metals have been found suitable.

Prior to thermal spray coating, the interior surface 56 of the annular portion 32 of the housing, hub or carrier 30 adjacent the open end edge 54 preferably undergoes treatment to provide an irregular surface finish which improves adherence of the sprayed thin steel coating 58. The approximate thickness of the steel coating is 0.5 mm. (0.0197 inches) but may be thicker or thinner. The thermal spray process may be one of several similar processes, namely, high velocity oxygen fuel, powder plasma, plasma transferred wire arc or two wire arc.

The housing, hub or carrier 30 of the present invention which is fabricated of aluminum thus provides significant weight savings which reduces both total vehicle weight and rotating (powertrain) weight while also functioning as a tone wheel with a conventional magnetic speed sensor. Additionally, the aluminum housing, hub or carrier 30 may be fabricated as a dimensionally identical replacement so that it may be retrofit into existing apparatus and applications.

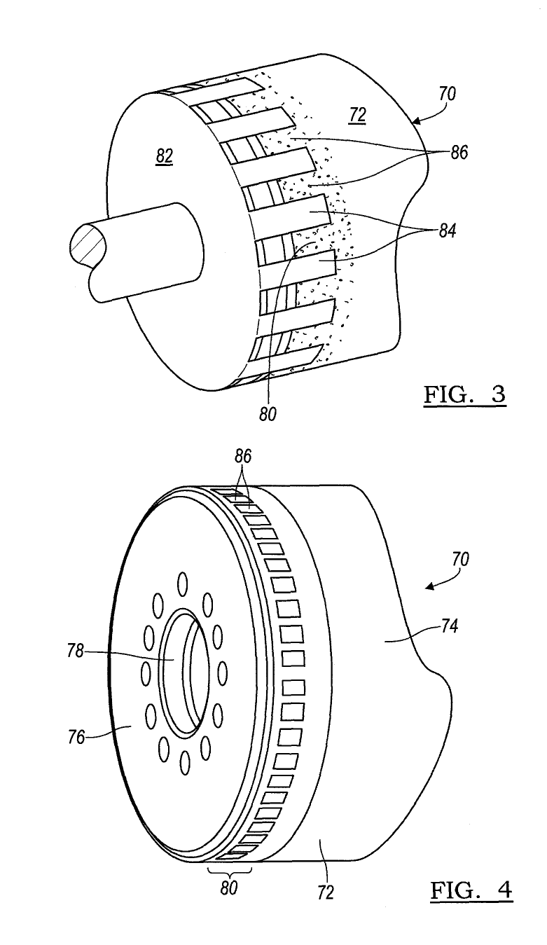

Referring now to FIGS. 3 and 4, it should be appreciated that design and engineering requirements may necessitate use of a housing, hub, carrier or similar component that cannot include conventional tone wheel openings or slots, that is, the rotating cylindrical or annular component must define a solid wall without interruptions. The annular or cylindrical component 70 illustrated in FIG. 3, which may be a housing, hub, carrier or other rotating component of an automatic transmission is so constrained and includes a solid, that is, uninterrupted, exterior cylindrical wall and surface 72. The annular or cylindrical component 70 is otherwise generally configured like the housing, hub or carrier 30, includes an open end 74, a closed end 76, with or without spokes, with a bushing or bearing mount 78 and is fabricated of aluminum.

Prior to thermal spray coating, the exterior cylindrical surface 72 of the annular or cylindrical component 70 adjacent the open end 74 or closed end 76 preferably undergoes treatment to provide an irregular surface finish which improves adherence of a sprayed thin steel coating 80. Also prior to thermal spray coating, a mask 82 which may be either a physical device with a plurality of teeth or fingers 84 or a chemical resist agent may be disposed adjacent the open end 74 or closed end 76 to provide a pattern of circumferentially uniform, alternating regions or patches 86 where the thin steel coating 80 will adhere and reside or where no thin steel coating 80 will be present. The approximate thickness of the steel coating is 0.5 mm. (0.0197 inches) but it may be thicker or thinner. The thermal spray process may be one of several similar processes, namely, high velocity oxygen fuel, powder plasma, plasma transferred wire arc or two wire arc.

Alternatively, a circumferential area or the cylindrical surface 72 or radial end face 76 of the cylindrical component 70 such as a housing, hub or carrier lacking tone wheel openings may be thermally spray coated to provide a continuous thin metal coating 80. The thermally sprayed thin metal coating 80 may be low carbon steel such as SAE 1008 or 1010 or a similar alloy, metal or iron. It can then be machined by hobbing, shaper cutting, milling or a similar process to remove patches or regions of the thermally sprayed steel coating 80 and aluminum. What remains is steel coated aluminum teeth-like regions or patches 86 on the cylindrical surface 72 or radial end face 76 of the cylindrical component 70 as illustrated in FIG. 4.

FIG. 4 illustrates the finished product of FIG. 3 in which the annular or cylindrical component 70 fabricated of aluminum and having a solid, that is, uninterrupted, exterior cylindrical surface 72 also includes a plurality of circumferentially spaced-apart regions or patches 86 of a thin steel, thermally sprayed coating 80 which functions, in cooperation with a magnetic speed sensor 60 (illustrated in FIG. 1), as a tone wheel. Thus, and once again, the weight saving of aluminum is combined in a transmission component which may be dimensionally identical with an existing part so that it may be retrofit and which includes the ability to sense rotational speed with a conventional magnetic speed sensor.

The description of the invention is merely exemplary in nature and variations that do not depart from the gist of the invention are intended to be within the scope of the invention. Such variations are not to be regarded as a departure from the spirit and scope of the invention.

What is claimed is:

1. An aluminum housing for a clutch of an automatic transmission comprising, in combination,
an annular portion having a first end and an axially separated second end,
a radially extending end member merging with said second end of said annular portion and
a mounting bushing centered in said end member, said annular portion of said housing defining a plurality of circumferentially arranged and spaced apart openings and a ferrous coating on said annular portion adjacent said openings.

2. The aluminum housing for a clutch of claim 1 wherein said ferrous coating is one of SAE 1008 steel, SAE 1010 steel and iron.

3. The aluminum housing for a clutch of claim 1 wherein said end member defines a plurality of spokes.

4. The aluminum housing for a clutch of claim 1 wherein said annular portion includes an interior surface and said ferrous coating resides on said interior surface.

5. The aluminum housing for a clutch of claim 1 wherein said ferrous coating is approximately 0.0197 inches in thickness.

6. The aluminum housing for a clutch of claim 1 further including a magnetic speed sensor disposed in sensing relationship with said plurality of circumferentially arranged and spaced apart openings.

7. The aluminum housing for a clutch of claim 1 further including an interior surface having female splines adapted to engage plates of a friction clutch assembly.

8. An aluminum clutch housing adapted for use in an automatic transmission comprising, in combination,
a cylindrical portion having an outside surface, a first end and an axially spaced apart second end,
a radially extending end panel merging with said second end of said cylindrical portion and a mounting opening in said end panel, said cylindrical portion of said housing defining a plurality of circumferential, spaced apart openings and a ferrous coating on said cylindrical portion adjacent said openings.

9. The aluminum clutch housing of claim 8 wherein said ferrous coating is one of SAE 1008 steel, SAE 1010 steel and iron.

10. The aluminum clutch housing of claim 8 wherein said end panel includes a plurality of spokes.

11. The aluminum clutch housing of claim 8 wherein said cylindrical portion includes an exterior surface and said ferrous coating resides on said exterior surface.

12. The aluminum clutch housing of claim 8 wherein said ferrous coating is approximately 0.0197 inches in thickness.

13. The aluminum clutch housing of claim 8 further including a magnetic speed sensor disposed in sensing relationship with said plurality of circumferential, spaced apart openings.

14. The aluminum clutch housing of claim 8 further including an interior surface having female splines adapted to engage plates of a friction clutch assembly.

15. An aluminum clutch housing adapted for use in an automatic transmission comprising, in combination,
a cylindrical portion having an outside surface, a first end and an axially spaced apart second end,
a radially extending end panel merging with said second end of said cylindrical portion and a mounting opening in said end panel, said outside surface of said cylindrical portion of said housing having a plurality of regions of ferrous material having axially oriented, parallel edges, said plurality of regions forming a tone wheel.

16. The aluminum clutch housing of claim 15 wherein said ferrous coating is one of SAE 1008 steel, SAE 1010 steel and iron.

17. The aluminum clutch housing of claim 15 wherein said ferrous coating is approximately 0.0197 inches in thickness.

18. The aluminum clutch housing of claim 15 further including a magnetic speed sensor disposed in sensing relationship with said plurality of regions of ferrous material.

19. The aluminum clutch housing of claim 15 further including an interior surface having female splines adapted to engage plates of a friction clutch assembly.
